(19) United States
(12) Patent Application Publication
(10) Pub. No.: US 2020/0023749 A1
(43) Pub. Date: Jan. 23, 2020

(54) METHOD FOR CONTROLLING STATE OF CHARGE OF ELECTRIC POWER STORAGE DEVICE FOR MOTOR-DRIVEN VEHICLE WITHOUT REVERSE GEAR

(71) Applicants: Hyundai Motor Company, Seoul (KR); Kia Motors Corporation, Seoul (KR)

(72) Inventors: Seung Han Lee, Anyang (KR); Chang Min Lee, Anyang (KR); Seong Hwan Cheong, Suwon (KR); Jun Geol Song, Seoul (KR)

(21) Appl. No.: 16/203,909

(22) Filed: Nov. 29, 2018

(30) Foreign Application Priority Data
Jul. 23, 2018 (KR) 10-2018-0085568

(51) Int. Cl. B60L 58/12; B60W 10/26; B60L 50/15; B60L 50/16

(52) U.S. Cl. CPC B60L 58/12; B60L 50/16; B60L 50/15; B60W 10/26

(57) ABSTRACT

A method for controlling a state of charge of an electric power storage device for a motor-driven vehicle without a reverse gear includes providing a plurality of driving sources but does not include a reverse gear and implements backward driving of the vehicle by reversely driving a motor as one of the driving sources, and further includes determining whether or not backward uphill driving is necessary, monitoring the state of charge of the electric power storage device when it is determined that the backward uphill driving is necessary, and controlling the state of charge of the electric power storage device based on the monitored state of charge of the electric power storage device.

### CROSS REFERENCE TO RELATED APPLICATION

The present application claims under 35 U.S.C. § 119(a) the benefit of Korean Patent Application No. 10-2018-0085568 filed on Jul. 23, 2018 in the Korean Intellectual Property Office, the entire contents of which are incorporated by reference herein.

### BACKGROUND

### (a) Technical Field

The present disclosure relates to a method for controlling a state of charge of an electric power storage device for a motor-driven vehicle without a reverse gear, more particularly, to the method for controlling the state of charge that secures enough state of charge of the electric power storage device for backward driving, so as to allow the vehicle to be driven backwards by reversing the motor without the reverse gear.

### (b) Description of the Related Art

Conventional vehicles implement backward driving by converting engine or motor power in the reverse direction to transmit it to a transmission through a reverse idle gear. The general principle is that because the primary power source of the vehicle is the engine, the engine is not to rotate in reverse.

However, in a hybrid electric vehicle (HEV), a fuel cell vehicle (FCEV), or an electric vehicle (EV) and the like, it is possible to drive backward through a reverse rotation of a motor without a reverse idle gear by using a reversely rotatable motor as a power source.

However, in a hybrid vehicle including a plug-in type hybrid vehicle, since it should implement backward driving by rotating only a motor in reverse in a state of blocking power through an engine clutch from an engine that cannot reversely rotated, it is important to supply enough power to the motor via the motor specifications and the performance of the battery.

FIG. 1 (RELATED ART) shows a power delivery flow of a hybrid vehicle including a conventional reverse idle gear.

Referring to FIG. 1, since a hybrid vehicle including a conventional reverse idle gear converts power in a reverse direction through the reverse idle gear, the rotating direction of an engine 10 and a motor 20 is the same as that of forward running. However, the power is converted to the reverse direction in a transmission 40 to be transmitted to the output side of a differential gear.

Therefore, when the power required for backward driving is large, if the output of the motor 20 or the power amount of a battery 50 is not sufficient, an engine clutch 30 is coupled and the power of the engine 10 is directly transmitted to the motor 20, so that it is possible to directly utilize the power of engine 10.

FIG. 2 shows a power delivery flow of a hybrid vehicle that does not include a reverse idle gear according to an exemplary embodiment of the present disclosure.

Referring to FIG. 2, in the case of a hybrid vehicle that does not include a reverse idle gear, the engine clutch 30 should be disengaged in order to drive the motor 20 in the reverse direction. Accordingly, it is necessary to indirectly utilize the power of the engine 10 by charging the battery 50 through a generator 60 (HSG: Hybrid Starter Generator) depending on the idling state of the engine 10.

Therefore, in the case of driving the vehicle backward, since the power of the engine 10 is not directly transmitted, backward driving should be implemented only by the output of the motor 20 through the power supplied by the battery 50, which causes a problem in that the state of charge of the battery 50 must be large enough in order to secure sufficient output of the motor 20 in a situation where a large amount of power is required, such as backward uphill driving.

The foregoing is intended merely to aid in the understanding of the background of the present disclosure, and is not intended to mean that the present disclosure falls within the purview of the related art that is already known to those skilled in the art.

### SUMMARY

Accordingly, the present disclosure discloses a method for controlling a state of charge of an electric power storage device in order to secure a sufficient motor output when a motor-driven vehicle without a reverse gear drives backward.

A method for controlling a state of charge of an electric power storage device for a motor-driven vehicle without a reverse gear according to the present disclosure includes providing a plurality of driving sources but does not include a reverse gear and implements backward driving of the vehicle by reversely driving a motor as one of the driving sources, determining whether or not backward uphill driving is necessary, monitoring a state of charge of an electric power storage device when it is determined that the backward uphill driving is necessary, and controlling the state of charge of the electric power storage device based on the monitored state of charge of the electric power storage device.

It may be determined based on map information pre-stored in a memory or input from the outside in determining whether or not the backward uphill driving is necessary.

It may be determined that the backward uphill driving is necessary when a gradient of a road is equal to or greater than a predetermined minimum gradient in the map information in determining whether or not the backward uphill driving is necessary.

The minimum gradient may be preset to a gradient in which the motor output required for the backward uphill driving at a predetermined reference vehicle speed is equal to or greater than the power obtained by subtracting the consumed power of an electric load from the idle state charging power of a generator.

It may be determined that the backward uphill driving is not necessary if the road is recognized as having no backward driving possibility of the vehicle among the map information in determining whether or not the backward uphill driving is necessary.

It may be determined whether or not backward uphill driving is necessary based on a driving record of the vehicle pre-stored in a memory in determining whether or not the backward uphill driving is necessary.

A required state of charge of the electric power storage device calculated based on the driving energy required for the backward uphill driving may be compared with the state of charge of the electric power storage device under a standard condition as an expected gradient in monitoring the state of charge of the electric power storage device.

The standard condition may be a condition that the vehicle drives uphill backward at reference acceleration for a reference time.

The required state of charge of the electric power storage device may be calculated by adding the state of the charge of the electric power storage device corresponding to the required driving energy to a predetermined minimum state of charge of the electric power storage device.

The state of charge of the electric power storage device may be varied by controlling the charging or discharging of the electric power storage device based on the monitoring result of the state of charge of the electric power storage device in controlling the state of charge of the electric power storage device.

The power distribution may be controlled in a direction of charging the electric power storage device when the state of charge of the electric power storage device is lower than the required state of charge of the electric power storage device in controlling the state of charge of the electric power storage device.

The power distribution may be controlled in a direction of maintaining the state of charge of the electric power storage device when the state of charge of the electric power storage device is equal to or greater than the required state of charge of the electric power storage device in controlling the state of charge of the electric power storage device.

The method for controlling the state of charge of the motor-driven vehicle without the reverse gear according to the present disclosure may have the following effects. That is, it is possible to reduce the cost while reducing the weight of the transmission by eliminating the reverse gear and parts related thereto.

Further, it is possible to improve the power delivery efficiency of the transmission, thereby improving fuel efficiency.

Further, it is possible to improve fuel efficiency and reduce cost by controlling the effective use of the state of charge without increasing the capacity of the battery.

In addition, by implementing the backward driving by using the forward gear, it is possible to improve the phenomenon of shifting delay sensitivity, shifting shock and shifting noise caused by shifting using reverse gear and forward gear repeatedly.

### BRIEF DESCRIPTION OF THE DRAWINGS

The above and other objects, features and other advantages of the present disclosure will be more clearly understood from the following detailed description when taken in conjunction with the accompanying drawings, in which:

FIG. 1 (RELATED ART) shows a power delivery flow of a hybrid vehicle having a conventional reverse gear;

FIG. 2 shows a power delivery flow of a hybrid vehicle without a reverse gear according to an exemplary embodiment of the present disclosure;

FIG. 3 is a flowchart illustrating a method for controlling a state of charge of the electric power storage device for a motor-driven vehicle without a reverse gear according to an exemplary embodiment of the present disclosure;

FIG. 4 is a graph showing the minimum gradient required for backward uphill driving;

FIG. 5A shows a state of charge (SOC) control band for controlling the state of charge (SOC) of the electric power storage device in a normal driving situation; and

FIG. 5B shows the SOC control band for controlling the state of charge (SOC) of the electric power storage device in preparation for backward uphill driving.

### DETAILED DESCRIPTION OF THE DISCLOSURE

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

The specific structural or functional descriptions for exemplary embodiments disclosed in the present specification or the present application are illustrated only for the purpose of illustrating exemplary embodiments according to the present disclosure and exemplary embodiments according to the present disclosure can be implemented in various forms and should not be construed as limited to the exemplary embodiments described in this specification or application.

Since the exemplary embodiments according to the present disclosure can make various changes and have various forms, so specific exemplary embodiments will be illustrated in the drawing and described in detail in this specification or application.

It should be understood, however, that this is not intended to limit the exemplary embodiments according to the concept of the present disclosure to any particular mode of disclosure, but to include all modifications, equivalents, and alternatives falling within the spirit and scope of the present disclosure.

When any constituent elements are referred to as being “connected with” or “connected” to other constituent elements, it is understood that it may be directly connected or connected to the other constituent elements but the other components may be present in the middle.

On the other hand, when any constituent elements are referred to as being “directly connected with” or “directly connected” to other constituent elements, it should be understood that there are no other constituent elements in therebetween.

Unless otherwise defined, all terms used herein, including technical or scientific terms, have the same meaning as commonly understood by one of ordinary skill in the art to which the present disclosure pertains.

Terms such as those defined in commonly used dictionaries should be construed as meaning consistent with the meaning of the context in the relevant art and are not to be construed as ideal or overly formal meaning unless expressly defined in this specification.

Hereinafter, the present disclosure will be described in detail below by explaining preferred embodiments of the present disclosure with reference to accompanying drawings.

The same reference numerals shown in each drawing represent the same member.

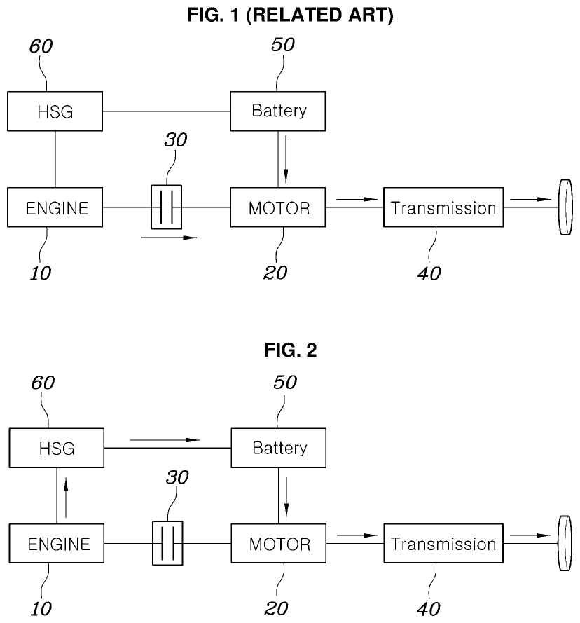

First, referring to FIGS. 1 and 2, the power system of a hybrid vehicle may include an engine 10 and a motor 20 as driving power sources, an engine clutch 30 and a transmission 40 for power delivery, and a generator 60 (Hybrid Starter Generator (HSG)), which is used in starting the engine 10 and a power storage for driving the engine 10 and the motor 20, and converts the power of the engine 10 to electric power after starting.

In addition, in order to control the above-mentioned components, a top-level hybrid controller (Hybrid Control Unit (HCU)), a motor controller (Motor Control Unit (MCU)), and a battery 50 controller (Battery Management System (BMS)) preferably are provided.

Particularly, the engine 10 on/off and the power distribution of the engine 10 and the motor 20 are determined by various factors such as vehicle speed, accelerator pedal depth (APS Depth), shifting stages, and the like. Among them, the state of charge (SOC) of the electric power storage device is the most important factor.

The electric power storage device is an energy source for driving the motor 20 of the hybrid vehicle. The battery 50 controller (BMS), which controls the electric power storage device, monitors the voltage, current, and temperature of the battery 50 to control and manage the state of charge (SOC [%]) of the electric power storage device overall.

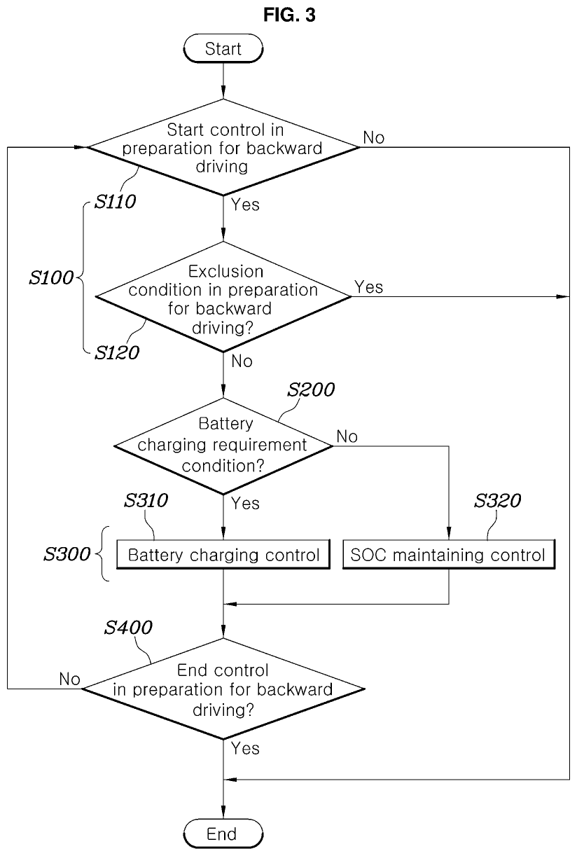

FIG. 3 is a flowchart illustrating a method for controlling a state of charge of an electric power storage device for a motor-driven vehicle without a reverse gear according to an exemplary embodiment of the present disclosure.

Referring to FIG. 3, a method for controlling a state of charge of an electric power storage device for a motor-driven vehicle, which includes a plurality of driving sources but does not include a reverse gear, and implements backward driving of the vehicle by reversely driving a motor as a driving source, according to an exemplary embodiment of the present disclosure, may include a step S100 of determining whether or not backward uphill driving is necessary, a step S200 of monitoring a state of charge of an electric power storage device when it is determined that the backward uphill driving is necessary, and a step S300 of controlling the state of charge of the electric power storage device based on the monitored state of charge of the electric power storage device.

The step S100 of determining whether or not backward uphill driving is necessary may determine whether or not there is a possibility that the backward uphill driving is necessary on a road that the vehicle is currently driving and on a road ahead on which the vehicle is expected to drive.

Whether or not the backward uphill driving is necessary may be determined by using road information from a hybrid controller (HCU) or information sensed by a separate sensor.

The step S200 of monitoring the state of charge of the electric power storage device may determine whether the state of charge of the electric power storage device is capable of discharging electric power to the extent that the vehicle can be driven backward by only the output of the motor when it is determined that backward uphill driving is necessary.

The state of charge of the electric power storage device may be monitored through the battery controller (BMS) for controlling the electric power storage device.

The step S300 of controlling the state of charge of the electric power storage device based on the monitored state of charge of the electric power storage device may control the state of charge of the electric power storage device so that the state of charge of the electric power storage device is able to discharge electric power to the extent that the vehicle can be driven backward by only the output of the motor depending on the monitored state of charge of the electric power storage device.

The battery controller (BMS) may control the state of charge of the electric power storage device based on the monitored state of charge of the electric power storage device.

If the capacity of the electric power storage device is increased or the charging electric power of the generator (HSG: Hybrid Starter Generator) is increased in preparation for backward uphill driving, the cost and weight of components may increase and fuel efficiency may deteriorate.

Further, even in the case where the state of charge of the electric power storage device is always kept high in preparation for backward uphill driving, the area where the power of the battery is used while distributing the power may be reduced, thereby deteriorating fuel efficiency and running performance.

However, according to the present disclosure, in the case of the backward driving by rotating the motor reversely without the reverse gear, it is possible to secure the state of charge the electric power storage device so that even backward uphill driving on the road having the gradient is possible without increasing the capacity of the parts or deteriorating the fuel efficiency.

Specifically, in the step S100 of determining whether or not the backward uphill driving is necessary, it may be determined based on map information pre-stored in a memory or input from outside.

The map information may be a highly accurate map that can predict up to 20 km ahead of the current road information.

The map information may be stored in the memory included in the vehicle or received from the outside in real time using a communication network.

In the map information, if the gradient of the road ahead of the vehicle, on which the vehicle is expected to travel, is greater than or equal to the predetermined minimum gradient (x %), it can be determined that the backward uphill driving is necessary at step S110. In other words, it can be determined that the backward uphill driving is not necessary even if the vehicle drives backward on the road having the gradient less than the predetermined minimum gradient (x %).

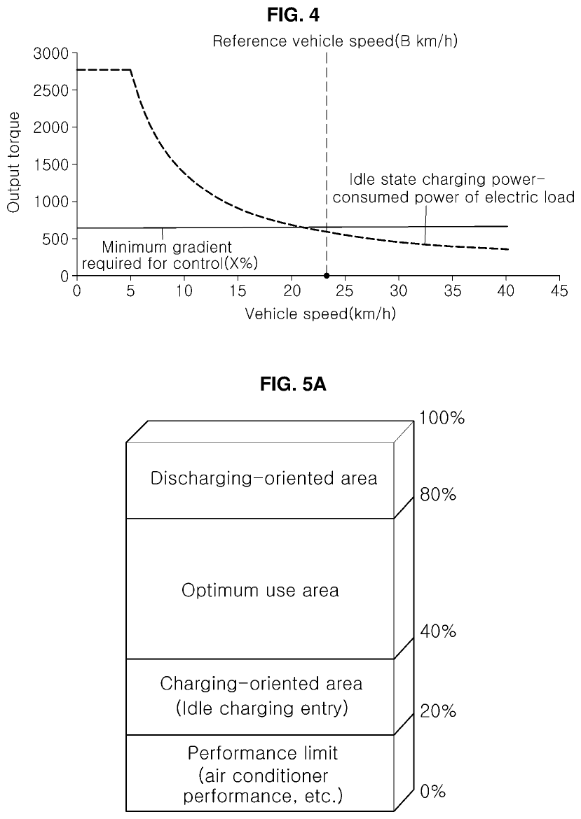

FIG. 4 is a graph showing the minimum gradient required for backward uphill driving.

Further, referring to FIG. 4, the predetermined minimum gradient (x %) may be preset to a gradient in which the motor output required for driving at a predetermined reference vehicle speed is equal to or greater than the power obtained by subtracting the consumed power of the electric load from the idle state charging power of the generator in the backward uphill driving. In other words, a motor output equal to or greater than the power obtained by subtracting the power of being consumed in the electric load from the power being charged in the electric power storage device by the generator is required during backward uphill driving at a predetermined reference vehicle speed, so that the predetermined minimum gradient may be preset to a gradient that requires discharge of the electric power storage device.

It is also possible to use the slope sensor of the vehicle itself, the vehicle speed sensor, and the torque sensor to detect the gradient of the road without using the map information.

Further, in the step S100 of determining whether the backward uphill driving is necessary, it is determined that the backward uphill driving is not necessary if the road is recognized as a road that the vehicle is not allowed to drive backward among the map information at step S120.

For example, in the case where the road is recognized as a road that the vehicle is not allowed to drive backward such as a general passage road or a highway, and the like based on map information including road information, it is determined that the backward uphill driving is not necessary.

After the step S110 of comparing the gradient of the road with the predetermined gradient, the possibility of the backward driving of the vehicle can be determined at step S120. Even if the gradient of the road is determined to be equal to or greater than the predetermined gradient, if the road is recognized as having no possibility of the vehicle backward driving, it can be determined that the backward uphill driving is not necessary.

Accordingly, the present disclosure controls the state of charge of the electric power storage device by determining whether or not the backward uphill driving is necessary, and minimizes the control interval to maintain the state of charge of the electric power storage device at a high level in preparation for the backward uphill driving, thereby improving fuel efficiency and driving performance.

As another exemplary embodiment, in the step S100 of determining whether the backward uphill driving is necessary, it is possible to determine whether or not the backward uphill driving is necessary based on the stored driving history in memory.

Specifically, it may be controlled to store the map information and driving information of the corresponding road in the memory in the case where the backward uphill driving of the vehicle occurs during the vehicle is running. Accordingly, it is possible to determine that the backward uphill driving is necessary on the road in the memory in which the driving record, in which the backward uphill driving has occurred and is stored, during driving using the information stored in the memory.

Therefore, it is possible to prepare the driving pattern of the driver or the situation of the road which is not recognized through the driving record previously stored in the memory of the vehicle. That is, it can be recorded in the memory every time the backward uphill driving occurs, and it can be determined that the backward uphill driving is necessary by using the backward uphill driving record stored in the memory the next time the vehicle drives on the corresponding road.

As yet another exemplary embodiment, in the step S100 of determining whether the backward uphill driving is necessary, it may be determined that the backward uphill driving is necessary when a backward operation signal is input from the driver. That is, even if a reverse gear is not provided, when the driver inputs the shifting stage to a reverse stage (R) or inputs a backward driving operation signal through a separate control device, it can be determined that the backward uphill driving is necessary.

Accordingly, it is possible to determine whether or not the backward uphill driving is necessary without any complicated process and to secure fuel efficiency and driving performance by minimizing the state of charge control of the power storage device in preparation for backward uphill driving.

In the step S200 of monitoring the state of charge of the electric power storage device, it is possible to compare the required state of charge of the electric power storage device, which is calculated based on the driving energy required for the backward uphill driving under the condition of the expected reference gradient, with the state of charge of the (current) power storage device.

The required state of charge of the electric power storage device can be calculated by adding the predetermined minimum state of charge of the electric power storage device and the state of charge of the electric power storage device corresponding to the required driving energy. The minimum state of charge may be preset to the state of charge that the electric power storage device should maintain at a minimum level, as described below.

Herein, the reference condition may be a condition in which the vehicle drives uphill backward for the reference time at the reference acceleration. The reference acceleration can be set to a predetermined acceleration, for example, 0.4 [m/s²] as a development standard, and the reference time can also be set to 50 [sec] as the time predetermined as a development standard.

For example, if the expected gradient is 10 [%], the required output of the motor is 20 [kW] to drive the vehicle at the reference acceleration (0.4 [m/s²]), and the driving energy for maintaining this driving for the reference time (50 [sec]) can be calculated as 1000 [kJ].

Depending on the maximum state of charge of the electric power storage device, if the state of charge of the electric power storage device corresponding to 1000 [kJ] becomes 15.8 [%] of the maximum state of charge of the electric power storage device, the required state of charge of the power storage device can be calculated by the value adding 15.8 [%] to the predetermined minimum state of charge.

Therefore, in the step S200 of monitoring the state of charge of the electric power storage device, it will be possible to determine whether or not it is necessary to vary the state of charge by comparing the state of charge of the (current) electric power storage device with the required state of charge of the power storage device.

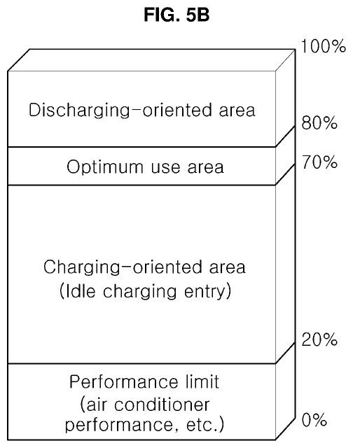

FIG. 5A shows an SOC control band for controlling the state of charge (SOC) of the electric power storage device in a normal driving situation, and FIG. 5B shows the SOC control band controlling the state of charge (SOC) of the electric power storage device in preparation for the backward uphill driving.

Referring to FIGS. 5A and 5B, in the step S300 of controlling the state of charge of the electric power storage device, the state of charge of the electric power storage device can be varied by controlling the charging or discharging of the electric power storage device based on the state of charge monitoring result of the electric power storage device.

When controlling the vehicle, the operating point should be set so that the state of charge of the electric power storage device is maintained in the optimum use area and it should be controlled to recover to the optimum use area if the state of charge the electric power storage device is out of the optimum use area.

Specifically, in the SOC band control of the electric power storage device, as the state of charge of the electric power storage device is lower, the engine is operated at a higher operating point than the required power, so that the state of charge of the electric power storage device should be controlled in a charge-oriented manner, but as the state of charge of the electric power storage device is higher, the state of charge of the power storage device should be controlled in a discharge-oriented manner so that the discharge amount to the motor is increased.

Specifically, FIG. 5A shows the SOC control band in a typical driving situation. As shown in FIG. 5A, the optimum use area with the SOC of 40% or more and 80% or less is formed to be wide, so that the fuel efficiency and power performance can be secured by freely charging or discharging the electric power storage device.

However, in the case of the SOC control band in preparation for backward uphill driving as shown in FIG. 5B, the optimum use area may be formed to be narrowed to a high range where the SOC is equal to or higher than 70% and less than 80%. That is, the electric power distribution can be controlled in a direction to charge the state of charge of the electric power storage device or in a direction to maintain the state of charge so that the state of charge of the electric power storage device can maintain to be larger than the required state of charge for the backward uphill driving. The electric power distribution can be controlled by the hybrid controller (HCU) as the top controller, so that the charging or discharging of the electric power storage device can be controlled by the battery controller (BMS) as a sub-controller.

Specifically, in the step S300 of controlling the state of charge of the electric power storage device, the power distribution can be controlled in the direction of charging the power storage device when the state of charge of the electric power storage device is smaller than the required state of charge of the electric power storage device at step S310.

Further, in the step S300 of controlling the state of charge of the electric power storage device, the power distribution can be controlled in the direction to maintain the state of charge of the electric power storage device when the state of charge of the electric power storage device is equal to or greater than the required state of charge of the electric power storage device at step S320.

The required state of charge of the electric power storage device can be calculated by adding the state of charge of the electric power storage device corresponding to the required driving energy and the predetermined minimum state of charge of the electric power storage device. The predetermined minimum state of charge of the electric power storage device may be the boundary between the optimal use area and the charge-oriented area, or the boundary between the performance limited area and the charge-oriented area.

That is, the minimum state of charge of the electric power storage device is a state of charge that the electric power storage device should keep to a minimum level, and the required state of charge can be calculated by adding the state of charge corresponding to the calculated driving energy required for the backward uphill driving to the minimum state of charge.

The backward driving can be realized by only driving the motor in the reverse direction without including the reverse gear by controlling the state of charge of the electric power storage device vehicle in preparation for the backward uphill driving.

A step S400 of determining whether to end the control in preparation for the backward uphill driving can be determined as the same condition as the step S100 of determining whether or not the backward uphill driving is necessary. That is, if it is determined that the backward uphill driving is no longer necessary, the control in preparation for the backward uphill driving can be terminated.

Although specific embodiments of the present disclosure has been described and illustrated, those skilled in the art will appreciate that various alternations and modifications are possible without departing from the technical spirit of the present disclosure as disclosed in the appended claims.

What is claimed is:

1. A method for controlling a state of charge of an electric power storage device for a vehicle without a reverse gear, the method comprising:
providing a plurality of driving sources and implementing backward driving of the vehicle by reversely driving a motor, which is one of the plurality of driving sources;
determining whether or not backward uphill driving is necessary;
monitoring the state of charge of the electric power storage device when it is determined that the backward uphill driving is necessary; and
controlling the state of charge of the electric power storage device based on the monitored state of charge of the electric power storage device.

2. The method of claim 1, wherein it is determined based on map information pre-stored in a memory or input from outside whether or not the backward uphill driving is necessary.

3. The method of claim 2, wherein it is determined that the backward uphill driving is necessary when a gradient of a road is equal to or greater than a predetermined minimum gradient in the map information.

4. The method of claim 3, wherein the minimum gradient is preset to a gradient in which motor output required for the backward uphill driving at a predetermined reference vehicle speed is equal to or greater than power obtained by subtracting a consumed power of an electric load from an idle state charging power of a generator.

5. The method of claim 2, wherein it is determined that the backward uphill driving is not necessary if a road is recognized as having no backward driving possibility of the vehicle based on the map information.

6. The method of claim 1, wherein it is determined whether or not the backward uphill driving is necessary based on a driving record of the vehicle pre-stored in a memory.

7. The method of claim 1, wherein the required state of charge of the electric power storage device calculated based on a driving energy required for the backward uphill driving is compared with the state of charge of the electric power storage device under a standard condition as an expected gradient in monitoring the state of charge of the electric power storage device.

8. The method of claim 7, wherein the standard condition is a condition that the vehicle drives uphill backward at a reference acceleration for a reference time.

9. The method of claim 7, wherein the required state of charge of the electric power storage device is calculated by adding the state of the charge of the electric power storage device corresponding to the required driving energy to a predetermined minimum state of charge of the electric power storage device.

10. The method of claim 1, wherein the state of charge of the electric power storage device is varied by controlling the charging or discharging of the electric power storage device based on the monitoring result of the state of charge of the electric power storage device in controlling the state of charge of the electric power storage device.

11. The method of claim 10, wherein a power distribution is controlled in a direction of charging the electric power storage device when the state of charge of the electric power storage device is lower than the required state of charge of the electric power storage device in controlling the state of charge of the electric power storage device.

12. The method of claim 10, wherein a power distribution is controlled in a direction of maintaining the state of charge of the electric power storage device when the state of charge of the electric power storage device is equal to or greater than the required state of charge of the electric power storage device in controlling the state of charge of the electric power storage device.
